(19) United States
(12) Patent Application Publication
(10) Pub. No.: US 2004/0045036 A1
(43) Pub. Date: Mar. 4, 2004

(54) Delivery system and method of real-time multimedia streams

(76) Inventor: Hiroshi Terasaki, Tokyo (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/647,591

(22) Filed: Aug. 26, 2003

(30) Foreign Application Priority Data
Aug. 27, 2002 (JP) 2002-247283

(51) Int. Cl. H04N 7/173

(52) U.S. Cl. 725/116; 725/115

(57) ABSTRACT

A real-time multimedia stream delivery system allows time-shift transition of real-time multimedia data. A transmitter delivers real-time multimedia data in multicast to receivers while storing the real-time multimedia data into a first storage. When having received a time-shift transition command from a receiver, the transmitter reads time-shifted multimedia data from the first memory depending on the time-shift transition command and transmits it in unicast to the receiver that originated the time-shift transition command.

### BACKGROUND OF THE INVENTION

1. Field of the Invention

The present invention relates to delivery techniques of real-time data streams and in particular to system and method of delivery in real-time data streams over a network.

2. Description of the Related Art

In general, a video transmission system may be divided into three main types of infrastructure: Television broadcasting such as Broadcasting Satellite (BS) or Communication Satellite (CS); Cable Television (CATV) broadcasting; and Internet broadcasting. A recent shift from analog-base to digital-base makes a wide variety of hitherto impossible services possible. In the field of Television broadcasting, for example, the following services become feasible:

Several hundred high-quality channels for providing programs;

EPG (Electronic Programming Guide);

Program reservations and watching using a home server;

Program-synchronization broadcasting such that, for example, a WWW homepage is synchronized to a program, which is realized in analog broadcasting systems such as ADAMS (TV-Asahi Data and Multimedia Service) or BitCast; and

Audience participation live program through Interactive (bidirectional) broadcasting.

In addition, there has been proposed a system such as Real Video G2, which is capable of presenting single content formed by combining content materials such as stored video data, audio data, and/or HTML document data. This conventional system allows the combined content materials to be synchronously displayed according to a predetermined scenario, achieving more widely various representations, compared with conventionally formed content.

Under these circumstances, a technique of multicasting live audio and video data, or real-time multimedia data, to a plurality of participants has received widespread attention, and therefore various multimedia content multicasting techniques have been proposed (for example, see U.S. Pat. No. 6,351,467 B1).

On the other hand, a live-video transmission system which transmits live video data from a transmitter to a receiver has been described in Japanese Patent Application Unexamined Publication No. P2001-45445A. More specifically, this live-video transmission system attaches picture ID and indexes to the live video data, allowing a user to select desired pictures of the live content. This conventional live-video transmission system is based on the unicast technology.

In the multicast delivery of real-time content streams, however, time-shifting operations of the real-time content, including pause, reverse, fast-forward, and time-shift replaying during recording, are not possible. In other words, it is impossible to play back awhile-precoding live video pictures. Taking an electronic conference using the multicasting technology as an example, when a participant is late for the electronic conference, the participant cannot reference previous presentation documents and therefore may not understand well a discussion that is currently made in the electronic conference.

### SUMMARY OF THE INVENTION

An object of the present invention is to provide a system and method for delivering real-time data streams allowing time-shifting operations such as pause, reverse, fast-forward, and time-shift replaying.

According to the present invention, a transmitter delivers real-time multimedia data in multicast to the receivers while storing the real-time multimedia data into a first memory. When having received a time shift transition command from a receiver, the transmitter reads time-shifted multimedia data from the first memory depending on the time-shift transition command. The time-shifted multimedia data is then transmitted in unicast to the receiver which originated the time-shift transition command. The receiver receives the real-time multimedia data in multicast from the transmitter before transmitting the time-shift transition command and receives the time-shifted multimedia data in unicast from the transmitter after transmitting the time-shift transition command.

The transmitter preferably adds a time stamp to each transmission block size of the real-time multimedia data, stores the real-time multimedia data with time stamps into the first memory, and delivers the real-time multimedia data with time stamps to the receivers.

The receiver preferably creates a thumbnail picture from the real-time multimedia data received from the transmitter each time an amount of real-time multimedia data per unit time exceeds a predetermined level, and stores thumbnail pictures with corresponding time stamps into a second memory so as to designate a desired thumbnail picture, allowing a desired location of the real-time multimedia data to be designated. In addition, when a time-shift request occurs, the receiver creates a time-shift transition command based on the thumbnail pictures with the corresponding time stamps stored in the second memory, and transmits the time-shift transition command to the transmitter so as to receive time-shifted multimedia data from the transmitter in unicast.

The time-shift transition command may be one of a replay start location designation command, a pause command, a reverse command, a slow-replay command, and a fast-forward command.

According to another embodiment, each of the receivers stores the real-time multimedia data received from the transmitter into a third memory and, when a time-shift request occurs, reads time-shifted multimedia data from the third memory depending on the time-shift request.

According to another aspect of the present invention, when having received a start request command from a receiver, the transmitter delivers real-time multimedia data in multicast to the receiver while storing the real-time multimedia data into a first memory. When having received a time-shift transition command from the receiver, the transmitter reads time-shifted multimedia data from the first memory depending on the time-shift transition command, to transmit the time-shifted multimedia data in unicast to the receiver which originated the time-shift transition command. When having received a termination request command from the receiver, the transmitter terminates multimedia data delivery to the receiver.

The transmitter may include: an input section for inputting real-time multimedia data; a multicast transmitter for transmitting the real-time multimedia data to each of the receivers; a first unicast transceiver for receiving a command from a receiver and transmitting a response to the receiver; a command analyzer for analyzing a command received from the receiver to determine a type of the received command; a first memory for storing the real-time multimedia data; and a first controller controlling the multicast transmitter, the unicast transceiver and the first memory, such that the real time multimedia data is delivered in multicast to each of the receivers while storing the real-time multimedia data into the first memory, wherein, when having received a time-shift transition command from a receiver, time-shifted multimedia data is read from the first memory depending on the time-shift transition command and is transmitted in unicast to the receiver which originated the time-shift transition command.

The receiver may include: a multicast receiver for receiving the real-time multimedia data from the transmitter; a second unicast transceiver for transmitting a command to the transmitter and receiving a response to the command from the transmitter; and a second controller controlling such that the real-time multimedia data is received in multicast from the transmitter before transmitting the time-shift transition command, and the time-shifted multimedia data is received in unicast from the transmitter after transmitting the time-shift transition command.

As described above, the real-time multimedia stream delivery system according to the present invention is provided with a multicast-unicast changeover mechanism for changing between real-time multimedia data delivery and time-shifted multimedia data delivery, which allows time-shifted replay in real-time multimedia streaming delivery. In other words, the real-time multimedia data is transmitted in multicast and the time-shifted multimedia data is transmitted on demand to a receiver in unicast. Accordingly, each receiver having relatively small amount of memory capacity can provide time-shifted replay without storing real-time multimedia data.

Further, when the receiver creates thumbnail pictures from the received real-time multimedia data, time stamps attached to the thumbnail pictures are stored into the storage device. Accordingly, by just designating and sending a desired thumbnail picture to the transmitter, a user-desired scene of real-time multimedia data can be easily replayed.

### BRIEF DESCRIPTION OF THE DRAWINGS

FIG. 1 is a block diagram showing a real-time stream delivery system according to a first embodiment of the present invention;

FIG. 2 is a block diagram showing a functional structure of a controller in the real-time stream delivery system according to the first embodiment;

FIG. 3 is a flow chart showing a transmission control operation of a transmitter in the real-time stream delivery system according to the first embodiment;

FIG. 4 is a flow chart showing a reception control operation of a receiver in the real-time stream delivery system according to the first embodiment;

FIG. 5 is a diagram showing a UDP format used in multicast transmission;

FIG. 6 is a diagram showing a TCP format used in unicast transmission;

FIG. 7 is a diagram showing the format of a command;

FIG. 8 is a diagram showing the time-varying amount of multimedia data for explanation of creating thumbnail images in the first embodiment;

FIG. 9 is a diagram showing a sequence of communication when a start request command is sent from the receiver to the transmitter in the first embodiment;

FIG. 10 is a diagram showing a sequence of communication when a time-shift transition command is sent from the receiver to the transmitter in the first embodiment;

FIG. 11 is a diagram showing a sequence of communication when a termination request command is sent from the receiver to the transmitter in the first embodiment;

FIG. 12 is a block diagram showing a real-time stream delivery system according to a second embodiment of the present invention; and

FIG. 13 is a block diagram showing a real-time stream delivery system according to a third embodiment of the present invention.

### DESCRIPTION OF THE PREFERRED EMBODIMENTS

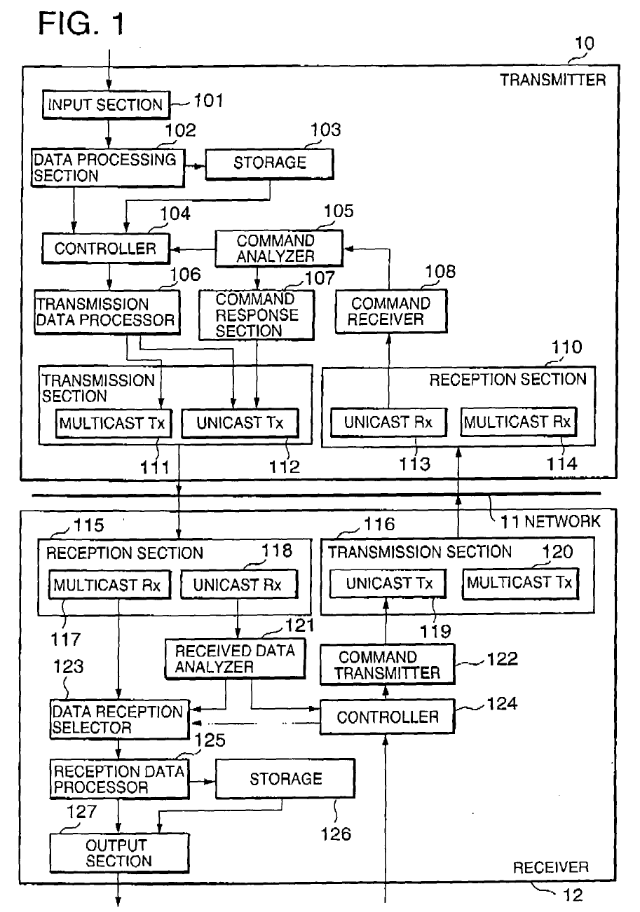

As shown in FIG. 1, it is assumed for simplicity that a delivery system of real-time multimedia streams according to a first embodiment of the present invention is composed of a transmitter 10 and a receiver 12, which are connected by a network 11. Needless to say, a plurality of receivers 12 may be connected to the network 11. The network 11 may be a communication network such as the Internet or Intranet. As described later, the transmitter 10 delivers real-time multimedia data such as live video data to the receiver(s) 12 in multicast through the network. When a time-shift replaying request occurs, the transmitter 10 delivers requested time-shifted multimedia data in unicast through the network 11 to the receiver 12 which originates that request. The detailed structures and operations of the transmitter 10 and the receiver 12 will be described hereinafter.

Transmitter

In the transmitter 10, an input section 101 inputs real-time multimedia data including still pictures, moving pictures, audio data, and/or text data from an input device such as still/video camera, microphone and the likes. Here, the multimedia data may be digital or analog.

A data processing section 102 receives the multimedia data from the input section 101 and performs data processing such as analog-to-digital conversion, format transform, and time stamp addition. The time stamp addition is to add time information (time stamp) to the multimedia data for each packet size. The multimedia data with time stamps added for each packet size are output to a controller 104 and stored in a storage device 103, which may be a memory device such as a hard disk drive (HDD).

The controller 104 inputs the output of the data processing section 102 and the output of the storage device 103 and selects one of these outputs depending on a command analytical result inputted from a command analyzer 105. The command analyzer 105 analyzes a command received by a command receiver 108 to output its analytical result to the controller 104 and a command response section 107. Depending on the analytical result, the controller 104 selects one of the output of the data processing section 102 and the output of the storage device 103 to output selected multimedia data with time stamps to a transmission data processor 106. Detailed structure and operation of the controller 104 will be described later.

The transmission data processor 106 assembles data packets from the multimedia data with time stamps and, if necessary, encrypts the payloads thereof. The data packets are outputted to a selected one of a multicast transmitter 111 and a unicast transmitter 112 of a transmission section 109.

The command response section 107 creates a command response packet according to the analytical result inputted from the command analyzer 105 and outputs it to the unicast transmitter 112.

The command receiver 108 receives a command packet from a certain receiver 12 through a unicast receiver 113 of a reception section 110 and outputs its command to the command analyzer 105. In this embodiment, a multicast receiver 114 of the reception section 110 is not used.

Receiver

In the receiver 12, the receiver 12 is provided with a reception section 115 including a multicast receiver 117 and a unicast receiver 118 and a transmission section 116 including a unicast transmitter 119 and a multicast transmitter 120. The multicast receiver 117 receives real-time multimedia data from the multicast transmitter 111 of the transmitter 10. The unicast receiver 118 receives time-shifted multimedia data or time-shift control data from the unicast transmitter 112 of the transmitter 10. In this embodiment, the multicast transmitter 120 is not used.

A received data analyzer 121 analyzes packets received from he transmitter 10 through the unicast receiver 118 to determine whether a received packet is a data packet or a command response packet. When the data packet is received, the received data analyzer 121 outputs it as time-shifted multimedia data to a data reception selector 123. When the command response packet is received, the received data analyzer 121 outputs it to a controller 124.

A command transmitter 122 inputs a command from the controller 124 to assemble a command packet. The command packet is outputted to the transmitter 10 through the unicast transmitter 119.

The data reception selector 123 selects one of the real-time multimedia data received from the multicast receiver 117 and the time-shifted multimedia data received from the received data analyzer 121 depending on an instruction inputted from the controller 124. A selected multimedia data is outputted to a reception data processor 125.

The controller 124 issues a command to a command transmitter 122, instructs the data reception selector 123 to perform received data selection as described above, and controls reception flag (TRUE/FALSE) and reception mode (real-time/time-shift) as described later.

The reception data processor 125 performs digital-to-analog conversion and format transform of received multimedia data, analyzes the received multimedia data and its attached time stamps, and creates thumbnail pictures depending on the amount of multimedia data per unit time, which will be described later.

A storage device 126 stores thumbnail pictures created by the reception data processor 125 together with time stamps. The storage device 126 may be a memory device such as a hard disk drive (HDD). An output section 127 inputs multimedia data from the reception data processor 125 and the thumbnail pictures from the storage device 126 and outputs and, as necessary, combines them to an external monitor (not shown).

Multicast and Unicast

Multicast transmission and Unicast transmission are defined as standards in RFC (Request For Comments) issued by IETF (Internet Engineering Task Force).

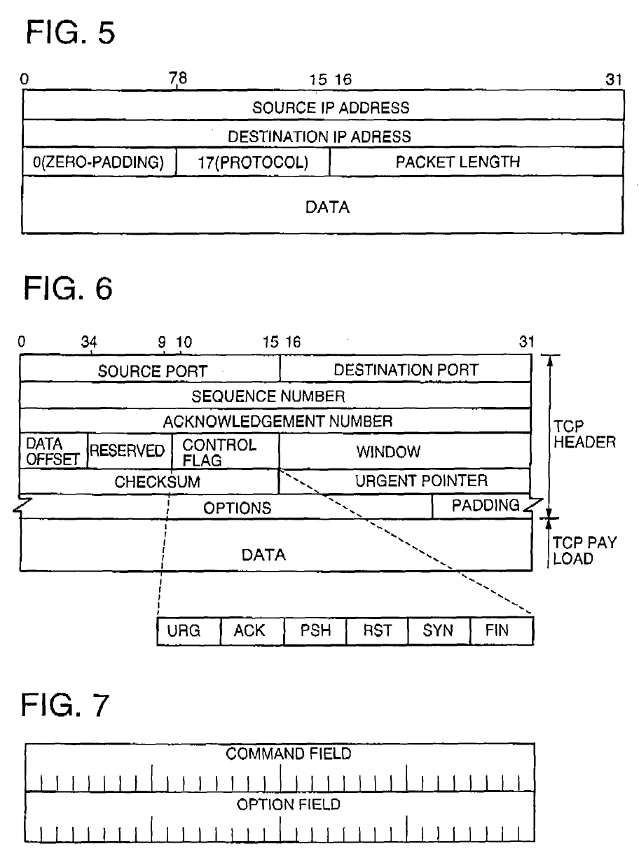

Multicast transmission is defined in RFC/68: User Datagram Protocol (UDP), in which UDP is used to transfer data. UDP has a relatively simple format composed of: Source/Destination IP address fields; Protocol field (here, protocol number “17” is assigned), Packet length field; and Data field (see FIG. 5).

Unicast transmission is defined in RFC793: Transmission Control Protocol (TCP), in which TCP is used to transfer data. TCP has a format composed of Source port field, Destination port field, Sequence number field (indicating the location of transmitted data), Acknowledgement number field (indicating the sequence number of next data to be transmitted), Data offset field (indicating the start location of data), Reserved field, Control flag field, Window field (indicating the window size), Checksum field, Urgent pointer field, Options field, Padding field, and Data field (see FIG. 6). In Control flag field, URG flag set to 1 indicates that the data field includes urgent data, ACK flag set to 1 indicates that the acknowledgement field is valid (ACK flag is normally set to 1 other than connection establishment), PSH (Push) flag set to 1 indicates that buffering is not performed, RST (Reset) flat set to 1 indicates that a connection is forced to be disconnected, SYN (Synchronize) flag set to 1 indicates that a connection tries to be established, and FIN (Finish flag set to 1 indicates that the connection tries to be disconnected. The urgent pointer field indicates the length of urgent data included in data when URG flag is set to 1.

Commands

A command is composed of a command field and an option field as shown in FIG. 7. The command field defines a command depending on what value is written therein. For example, a 101 valve indicates Replay command, a 103 indicates Pause command, a 104 indicates Fast-Forward command, a 105 indicates Reverse command, and a 106 indicates Thumbnail-based Replay Start Location Designation command.

The option field defines the following options for each command defined in the command field. In the case of Replay command, replay speed (normal or slow) and current time stamp are defined in the option field. In the case of Pause command, current time stamp is defined. In the case of Fast-Forward command, fast-forward speed with replaying or not and current time stamp are defined. In the case of Reverse command, reverse speed with replaying or not and current time stamp are defined. In the case of Thumbnail-based Replay Start Location Designation command, the designated time stamp is set in the option field.

The command field and the option field as described above allow both real-time replay and time-shift replay.

Controller of Transmitter

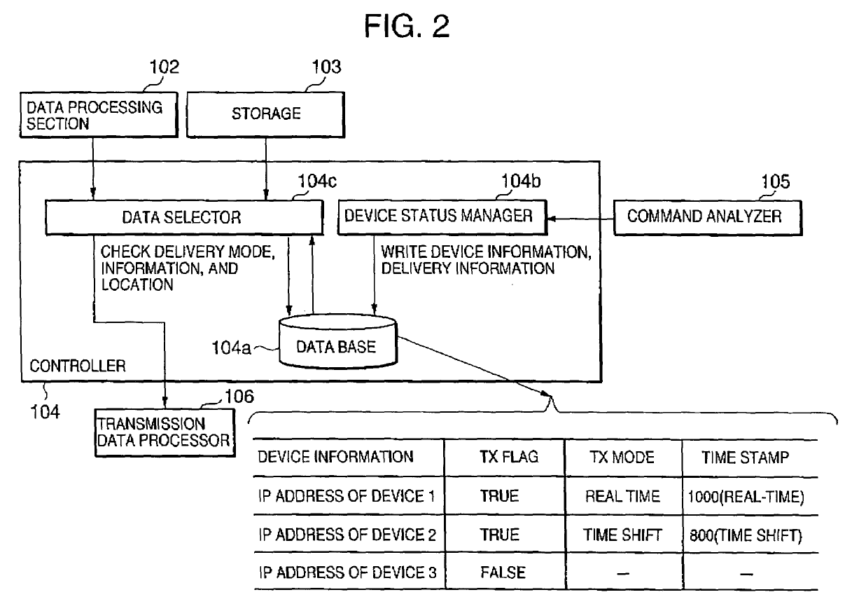

As shown in FIG. 2, the controller 104 of the transmitter 10 implements a database 104a, a device status manager 104b, and a data selector 104c. The database 104a stores a record composed of device information, transmission flag, transmission mode, and time stamp for each receiver 12. The device status manager 104b receives an analytic result from the command analyzer 105 to store as a record the device information identifying the receiver 12 that has transmitted a corresponding command and the delivery information composed of transmission flag, transmission mode, and time stamp. The device information identifies the receiver 12, which may be IP (Internet Protocol) address. The transmission mode includes “real-time”, “time-shift” and “not defined”. The transmission flag is one of TRUE and FALSE. The device information and the time stamp are extracted from a received command by the command analyzer 105.

The, data selector 104c selects one of the real-time multimedia data received from the data processing section 102 and the time-shifted multimedia data received from the storage device 103 depending on the device information and the delivery information stored in the database 104a.

In the case where a start request command for real-time multimedia delivery has been received from the receiver 12, the device status manager 104b searches the database 104a for the device information included in the received start request command. In this case, since no device information identifying the receiver 12 is found, the device status manager 104b registers a new record for the receiver 12 into the database 104a. For example, the device information is set to the IP address of the receiver 12, the transmission flag is set to TRUE, the transmission mode is set to “real-time”, and the time stamp is set to 1000.

The data selector 104c monitors the database 104a at all times and, when no change in device status of the receiver 12 occurs in the database 104a, selects the real-time multimedia data received from the data processing section 102 to output it to the transmission data processor 106.

Thereafter, when a time-shift transition command has been received from the receiver 12, the device status manager 104b searches the database 104a for the device information included in the received time-shift transition command. In this case, since the device information identifying the receiver 12 is found, the device status manager 104b sets the transmission mode of the record corresponding to the receiver 12 to “time-shift” and similarly sets the time stamp thereof to the shifted time stamp. When the transmission mode has been changed in the database 104a, the data selector 104c detects such a change and therefore selects the time-shift multimedia data received from the storage device 103 to output it to the transmission data processor 106.

When a termination command has been received from the receiver 12, the device status manager 104b searches the database 104a for the device information included in the received termination command. In this case, since the device information identifying the receiver 12 is found, the device status manager 104b sets the transmission flag of the record corresponding to the receiver 12 to “FALSE”. When the data selector 104c detects such a change, the data selector 104c stops delivery of real-time or time-shifted multimedia stream.

It should be noted that the controller 104 may be composed of a program-controlled processor implementing the data selector 104c and the device status manager 104b and a memory (not shown) separately implementing the database 104a.

Detailed control operations of the transmitter 10 and the receiver 12 will be described hereafter.

Operation of Transmitter

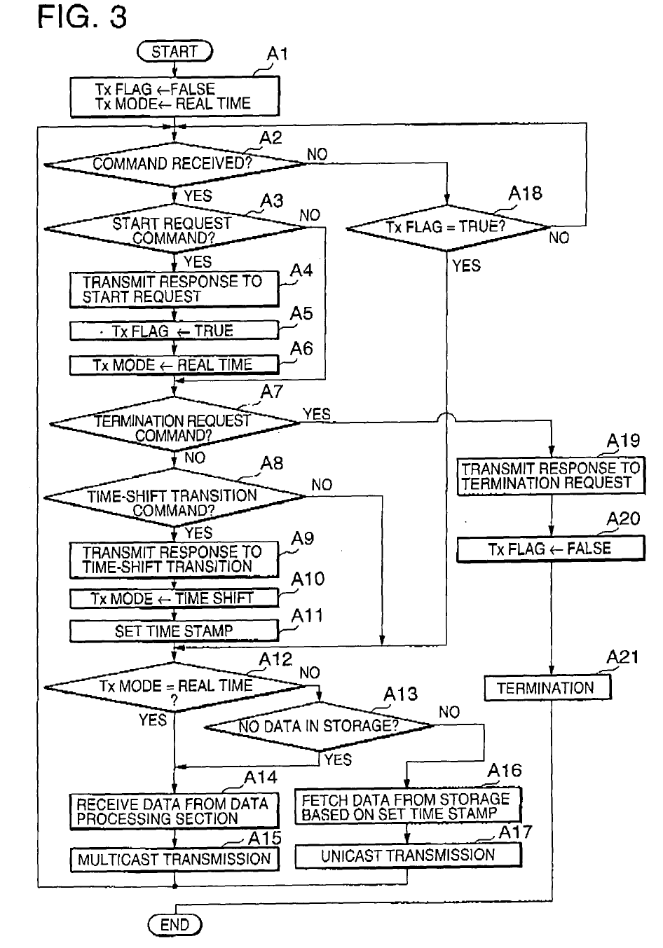

Referring to FIG. 3, the controller 104 first performs initialization of the database 104a such that the transmission flag is set to “FALSE” and the transmission mode to “real-time” (step A1). Thereafter, it is determined whether the command receiver 108 receives a command packet from a receiver 12 through the unicast receiver 113 (step A2). When no command has been received (No in step A2), it is further determined whether the transmission flag of the database 104a is “TRUE” (step A18). When the transmission flag is not “TRUE” (No in step A18), it means that neither real-time nor time-shifted multimedia data is delivered and therefore control goes back to the step A2.

When the transmission flag is “TRUE” (Yes in step A18), it means that real-time/time-shifted multimedia data is delivered to the receiver 12 identified by the device information corresponding to the transmission flag of TRUE and therefore the control goes to step A12, which will be described later.

When a command has been received (Yes in step A2), the command analyzer 105 analyzes the received command and the controller 104 performs delivery control depending on the command analytic result (steps A3-A11).

More specifically, when the received command is a start request command (Yes in step A3), the command analyzer 105 instructs the command response section 107 to acknowledge receipt of the start request command (step A4). The command response section 107 transmits a response to the start request command to the receiver 12 through the unicast transmitter 112. Thereafter, the device status manager 104b of the controller 104 registers device information of the receiver 12 and writes corresponding delivery information into the database 104a such that its transmission flag is set to “TRUE” (step A5) and its transmission mode is set to “real-time” (step A6).

When the received command is not a start request command (No in step A3) but a termination request command (Yes in step A7), the command analyzer 105 instructs the command response section 107 to acknowledge receipt of the termination request command (step A19). The command response section 107 transmits a response to the termination request command to the receiver 12 through the unicast transmitter 112. Thereafter, the device status manager 104b of the controller 104 writes the corresponding delivery information into the database 104a such that its transmission flag is reset to “FALSE” (step A20) and then the transmission process is terminated (step A21).

When the received command is neither a start request command (No in step A3) nor a termination request command (No in step A7) but a time-shift transition command (Yes in step A8), the command analyzer 105 instructs the command response section 107 to acknowledge receipt of the time-shift transition command (step A9). The command response section 107 transmits a response to a time-shift transition command to the receiver 12 through the unicast transmitter 112. Thereafter, the device status manager 104b of the controller 104 writes corresponding delivery information into the database 104a such that its transmission mode is set to “time-shift” (step A10) and its time stamp is set to its designated value (step A11). Such a time shift transition command includes a thumbnail based replay start location designation command, a pause command, a reverse command, a slow-replay command, or a fast-forward command. Hereinafter, it is assumed that a time shift transition command is a thumbnail-based replay start location designation command.

Subsequently, it is determined whether the current transmission mode of the corresponding receiver 12 indicates “real-time” (step A12). When it indicates “real-time” (Yes in step A12), the data selector 104c of the controller 104 receives real-time multimedia data from the data processing section 102 (step A14) and transfers it to the transmission data processor 106. The transmission data processor 106 assembles data packets from the real-time multimedia data with time stamps, and outputs them to the multicast transmitter 111 of the transmission section 109. In this way, the real time multimedia data is transmitted to the receiver 12 (step A15) and then the control goes back to the step A2.

In the case where the start request command is received after live performance or conference has started, the controller 104 preferably attaches preceding thumbnail pictures to the real-time multimedia data to be transmitted.

When the current transmission mode of the corresponding receiver 12 indicates “time-shift” (No in step A12), the controller 104 checks the presence or absence of data stored in the storage device 103 (step A13). When no time-shifted multimedia data is left in the storage device 103 (Yes in step A13), the data selector 104c of the controller 104 receives real-time multimedia data from the data processing section 102 (step A14) and transfers it to the transmission data processor 106. The transmission data processor 106 assembles data packets from the real-time multimedia data with time stamps, and outputs them to the multicast transmitter 111 of the transmission section 109. In this way, the real-time multimedia data is transmitted to the receiver 12 (step A15) and then the control goes back to the step A2. As described before, when the real-time multimedia data is transmitted after live performance or conference has started, the controller 104 preferably attaches preceding thumbnail pictures to the real-time multimedia data to be transmitted.

When time-shifted multimedia data is left in the storage device 103 (No in step A13), the data selector 104c of the controller 104 receives time-shifted multimedia data from the storage device 103 based on a time stamp value set in the database 104a corresponding to the receiver 12 (step A16) and transfers it to the transmission data processor 106. The transmission data processor 106 assembles unicast data packets from the time-shifted multimedia data with time-shifted time stamps and real-time time stamps, and outputs them to the unicast transmitter 112 of the transmission section 109. In this way, the time-shifted multimedia data is transmitted to the receiver 12 (step A17) and then the control goes back to the step A2.

Assuming that a time-shift transition command is a reverse command, at the step A11, the device status manager 104b of the controller 104 writes a current time stamp and a reverse interval received from the receiver 12 into the database 104a. At the step A16, the data selector 104c of the controller 104 fetches time-shifted multimedia data from the storage device 103 based on time stamp values sequentially calculated from the current time stamp and the reverse interval and outputs them to the transmission data processor 106. More specifically, the time stamp values are calculated by sequentially subtracting the reverse interval from the current time stamp. For example, assuming that the current time stamp is 100 and the reverse interval is 5, the data selector 104b sequentially fetches time-shifted multimedia data each corresponding to time stamps of 100, 95, 90, and so on from the storage device 103 at regular intervals (e.g. 1).

Assuming that a time-shift transition command is a slow-replay command, at the step A11, the device status manager 104b of the controller 104 writes a current time stamp and a slow replay interval received from the receiver 12 into the database 104a. At the step A16, the data selector 104c of the controller 104 fetches time-shifted multimedia data from the storage device 103 based on time stamp values calculated from the current time stamp and the slow-replay interval and outputs them to the transmission data processor 106. More specifically, the time stamp values are calculated by sequentially adding the slow-replay interval to the current time stamp. For example, assuming that the current time stamp is 100 and the slow-replay interval is 0.1, the data selector 104b sequentially fetches time-shifted multimedia data each corresponding to time stamps of 100, 100.1, 100.2 and so on from the storage device 103 at regular intervals (e.g. 1).

Assuming that a time-shift transition command is a fast-forward replay command, at the step A11, the device status manager 104b of the controller 104 writes a current time stamp and a fast-forward interval received from the receiver 12 into the database 104a. At the step A16, the data selector 104c of the controller 104 fetches time-shifted multimedia data from the storage device 103 based on time stamp values calculated from the current time stamp and the fast-forward interval and outputs them to the transmission data processor 106. More specifically, the time stamp values are calculated by sequentially adding the fast-forward interval to the current time stamp. For example, assuming that the current time stamp is 100 and the fast-forward interval is 5, the data selector 104b sequentially fetches time-shifted multimedia data each corresponding to the time stamps of 100, 105, 110 and so on from the storage device 103 at regular intervals (e.g. 1).

Assuming that a time-shift transition command is a pause command, at the step A11, the device status manager 104b of the controller 104 writes a current time stamp into the database 104a. At the step A16, the data selector 104c of the controller 104 fetches time-shifted multimedia data from the storage device 103 based on a time stamp value calculated from the current time stamp and outputs it to the transmission data processor 106. For example, assuming that the current time stamp is 100, the data selector 104b sequentially fetches time-shifted multimedia data corresponding to the time stamp of 100 from the storage device 103 at regular intervals (e.g. 1). When a pause release command has been received together with a current time stamp from the receiver 12, the controller 104 sequentially receives the following time-shifted multimedia data from the storage device 103 to transmit them to the receiver 12.

Operation of Receiver

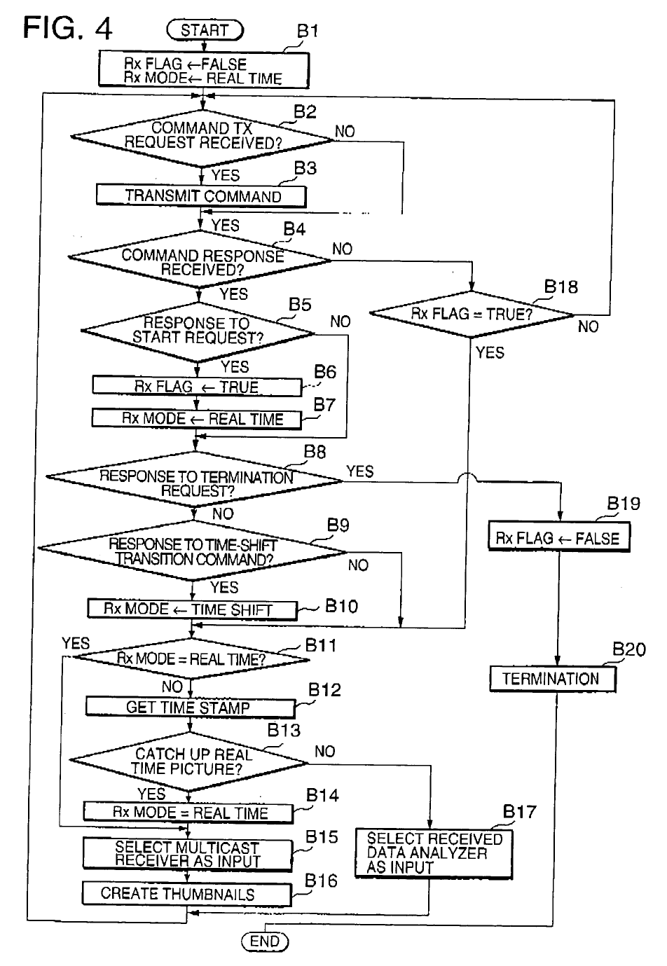

Referring to FIG. 4, the controller 124 first performs initialization such that the reception flag is set to “FALSE” and the reception mode to “real-time” (step B1). Thereafter, the controller 124 determines whether a command transmission request is received from outside user (step B2). When a command transmission request has been received (Yes in step B2), the controller 124 instructs the command transmitter 122 to transmit a requested command to the transmitter 10 through the unicast transmitter 110 of the transmission section 116 (step B3). Such a requested command may be a start request command, a thumbnail-based replay start location designation command, a pause command, a reverse command, a fast-forward command, a slow-replay command, a termination request command or the likes.

Thereafter, it is determined whether the received data analyzer 121 receives a command response at the unicast receiver 118 (step B4). When no command response has been received (No in step B4), it is further determined whether the reception flag is “TRUE” (step B18). When the reception flag is not “TRUE” (No in step B18), it means that neither real-time nor time-shifted multimedia data is received and therefore control goes back to the step B2.

When the reception flag is “TRUE” (Yes in step B18), it means that real-time/time-shifted multimedia data is received and therefore the control goes to step B11, which will be described later.

When a command response has been received (Yes in step B4), the received data analyzer 121 analyzes the received command response to determined whether it is a response to the start request command (step B5). When it is not a response to the start request command (No in step B5), the control goes to a step B8. When it is a response to the start request command (Yes in step B5), the controller 124 sets the reception flag to “TRUE” (step B6) and the reception mode to “real-time” (step B7).

Thereafter, the received data analyzer 121 determines whether the received command response is a response to the termination request command (step B8). When the received command is a response to the termination request command (Yes in step B8), the controller 124 sets the reception flag to “FALSE” (step B19) and terminates the process (step B20).

When the received command response is nota response to the termination request command (No in step B8), the received data analyzer 121 determines whether the received command response is a response to the time-shift transition command (step B9). When it is the response to the time-shift transition command (Yes in step B9), the controller 124 sets the reception mode to “time-shift” (step B10).

Subsequently, it is determined whether the current reception mode indicates “real-time” (step B11). When it indicates “real-time” (Yes in step B11), the data reception selector 123 selects real-time multimedia data received from the multicast receiver 117 of the reception section 115 (step B15) and transfers it to the reception data processor 125.

The reception data processor 125, as necessary, performs thumbnail creation (step B16) before back to the step B2. In the step B16, the reception data processor 125 monitors the amount of received real-time multimedia data and, when the amount of received data per unit time exceeds a predetermined threshold, creates thumbnail pictures from the received real-time multimedia data to store the thumbnail pictures with time stamps into the storage device 126.

When the current reception mode indicates “time-shift” (No in step B11), the data reception selector 123 gets a real-time time stamp of real-time multimedia data and a time-shifted time stamp of the time-shifted multimedia data attached to the real-time multimedia data (step B12). Thereafter, the data reception selector 123 determines whether a difference between the time-shifted time stamp and the real-time time stamp is smaller than a predetermined threshold, to decide on whether a time-shifted picture catches up the real-time picture (step B13).

When a time-shifted picture catches up the real-time picture (Yes in step B13), the controller 124 sets the reception mode to “real-time” (step B14). The data reception selector 123 selects real-time multimedia data received from the multicast receiver 117 of the reception section 115 (step B15) and transfers it to the reception data processor 125. The reception data processor 125 performs thumbnail creation (step B16) before back to the step B2. When a time-shifted picture does not catch up the real-time picture (No in step B13), the data reception selector 123 selects time-shifted multimedia data received from the received data analyzer 121 (step B17) and then the control goes back to the step B2.

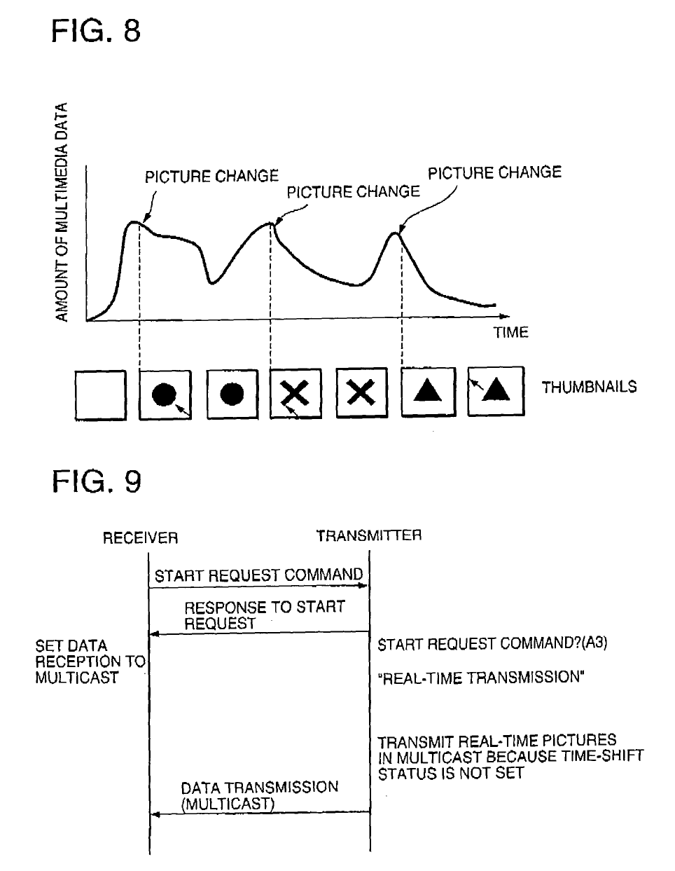

Taking a teleconference as an example, a presenter may use an electronic version of presentation documents to provide an explanation to conferees. In the teleconference application, there is seldom a case where an entire picture is changed during explanation of a single page. Accordingly, there is frequently used a delivery method such that difference data between a current frame and an immediately preceding frame or a several-second-old frame is delivered to reduce the load on the network as much as possible. In such a case, when breaking across pages, a picture is changed and thereby the amount of real-time multimedia data is increased as shown in FIG. 8. Therefore, the receiver 12 can easily detect page turning. At such page change timing, it is possible to create thumbnail pictures from the real-time multimedia data, by which the conferees can obtain an electronic version of presentation documents as the thumbnail pictures and further use the time stamps of the thumbnail pictures as indexes to designate replay start locations of the real-time multimedia data. Accordingly, when the present invention is applied to the teleconference application, it is possible for a conferee attending to the conference to check subjects on the agenda from the beginning of the conference. Further, when a conferee leaves the conference for a while, the conferee can check subjects on the agenda when the conferee is absent. Furthermore, a conferee can look at the foregoing several pages of the presentation documents delivered during the conference.

Sequential Operations

Sequential operations between the transmitter 10 and the receiver 12 will be described with reference to FIGS. 9-11.

As shown in FIG. 9, when a start request command has been sent from the receiver 12 to the transmitter 10, the transmitter 10 sends a response to the start request command back to the receiver 12 and sets the transmission mode to “real-time”. At the receiver 12, when having received the response to the start request command, the reception mode is set to “real-time.” In the transmitter 10, the controller 104 receives real-time multimedia data from the data processing section 102 and sends it to the receiver 12 in multicast.

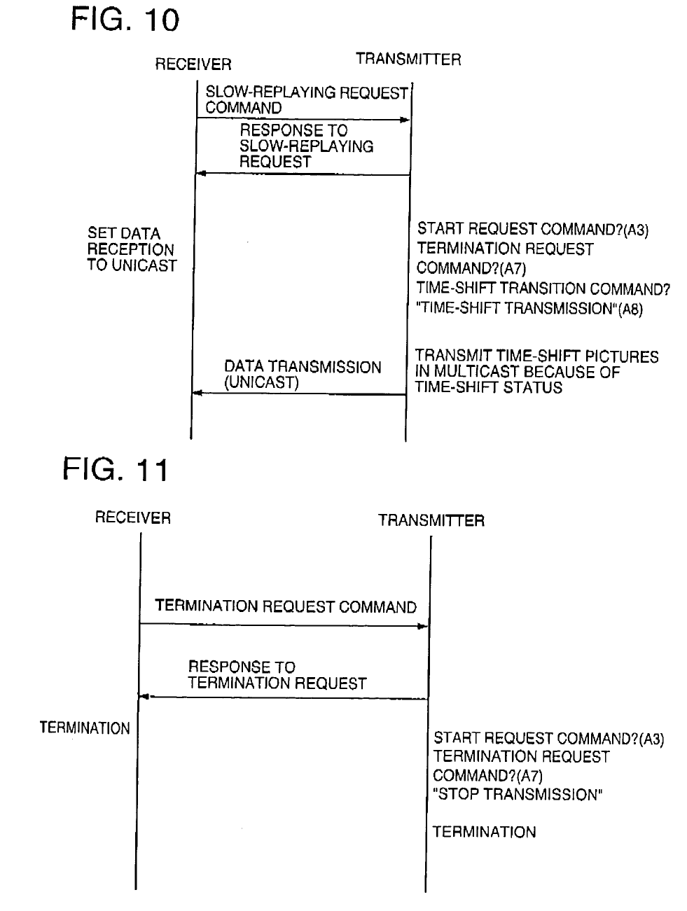

As shown in FIG. 10, when a slow-replaying request command has been sent from the receiver 12 to the transmitter 10, the transmitter 10 sends a response to the slow-replaying request command back to the receiver 12 and sets the transmission mode to “time-shift”. In the transmitter 10, the controller 104 receives time-shifted multimedia data from the storage device 103 and sends it to the receiver 12 in unicast.

As shown in FIG. 11, when a termination request command has been sent from the receiver 12 to the transmitter 10, the transmitter 10 sends a response to the termination request command back to the receiver 12 and terminates the transmission process.

Advantages

As described above, the real-time multimedia stream delivery system according to the first embodiment of the present invention is provided with a multicast unicast changeover mechanism for changing between real-time multimedia data delivery and time-shifted multimedia data delivery, which allows time-shifted replay in real-time multimedia streaming delivery.

Further, when the receiver creates thumbnail pictures from the received real-time multimedia data, time stamps attached to the thumbnail pictures are stored into the storage device. Accordingly, by sending a desired time stamp to the transmitter, a desired replay start location of real time multimedia data can be easily designated.

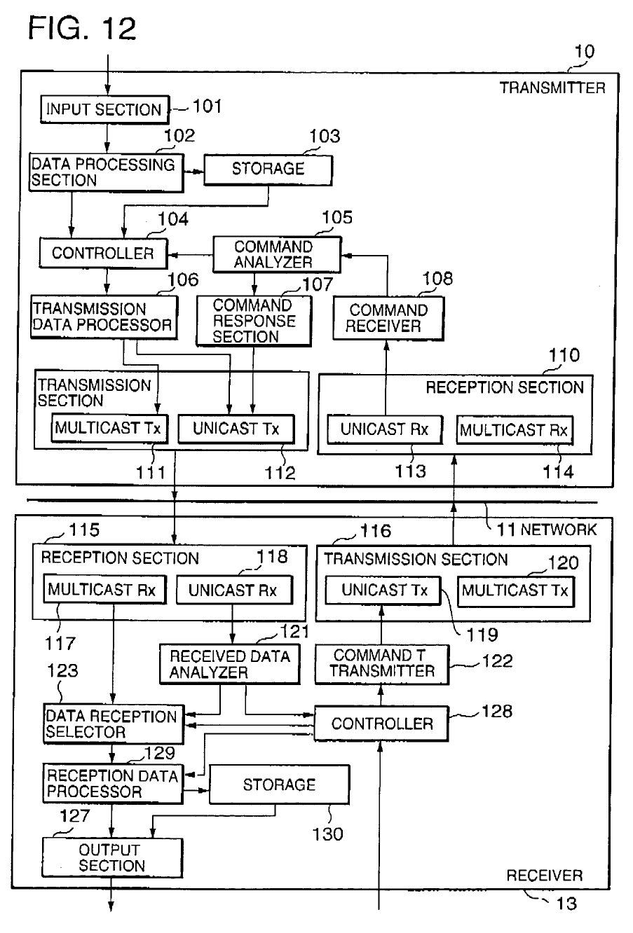

Referring to FIG. 12, a real-time multimedia stream delivery system according to a second embodiment of the present invention is composed of a transmitter 10 and a receiver 13, which are connected by a network 11. Needless to say, a plurality of receivers 13 may be connected to the network 11. Blocks similar to those previously described with reference to FIG. 1 are denoted by the same reference numerals and detailed descriptions thereof will be omitted.

As described in the first embodiment, the transmitter 10 delivers real-time multimedia data to the receiver(s) 13 in multicast through the network 11. When a time-shift replaying request occurs, the transmitter 10 delivers requested time-shifted multimedia data in unicast through the network 11 to the receiver 13 which originates that request.

According to the second embodiment, in addition, a storage device 130 of each receiver 13 is provided to store real-time multimedia data received from the transmitter 10 in multicast, which can be used for time-shift replaying under control of the controller 128. More specifically, a controller 128 of the receiver 13 instructs a reception data processor 129 to store the received real-time multimedia data into the storage device 130. Depending on user's instruction, the controller 128 can select one of an inside replay mode and an outside replay mode. The outside replay mode is that time-shift replaying is performed at the transmitter 10 as described in the first embodiment. The inside replay mode is that time-shift replaying is performed at the receiver 13 by reading time-shifted multimedia data from the storage device 130. The time-shifted multimedia data is designated by inputting a time-shift transition command similar to the first embodiment.

In order to store the necessary amount of real-time multimedia data received from the transmitter 10, the storage device 130 needs sufficient capacity, which may be implemented by hard disk drive (HDD). Further, the reception data processor 129 has functions of storing real-time multimedia data into the storage device 130 and instructing the storage device 130 to output time-shifted multimedia data to the output section 127 under the control of the controller 128.

As described above, according to the second embodiment, the inside and outside replay modes can be selected at a receiver. Since the inside replay mode allows time-shifting replay without transferring multimedia data through the network 11, the load on the network 11 can be dramatically reduced.

The above-described functions of the transmitter 10 may be implemented by transmitter control programs running on a program-controlled processor. Similarly, the above-described functions of the receiver 12 or 13 may be implemented by receiver control programs running on a program-controlled processor.

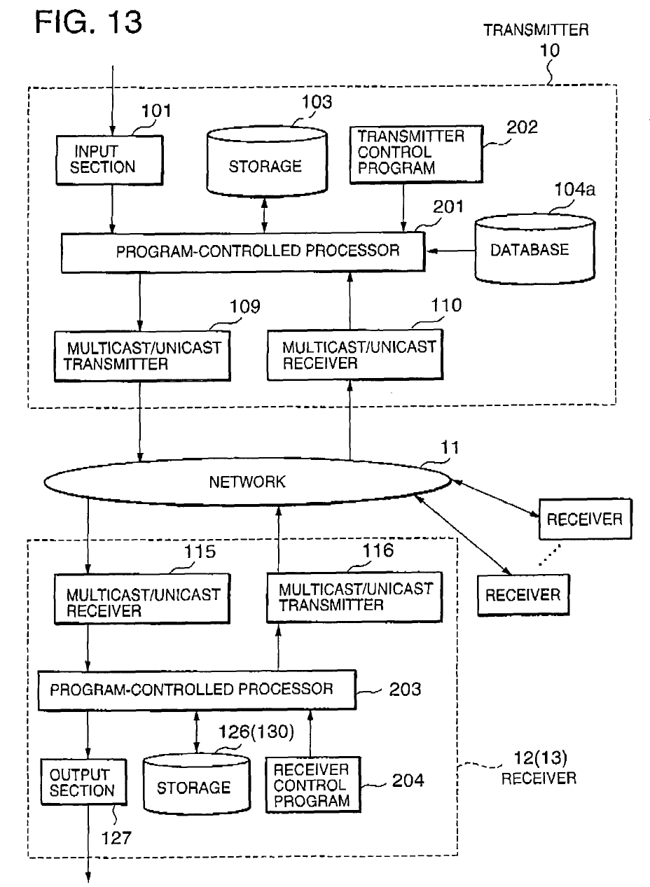

As shown in FIG. 13, the data processing section 102, the controller 104, the command analyzer 105, transmission data processor 106, the command response section 107, and the command receiver 108 may be implemented by transmission control programs stored in a memory 202 running on a program-controlled processor 201. Similarly, the received data analyzer 121, the command transmitter 122, data reception selector 123, the controller 124/128, and the reception data processor 125/129 may be implemented by reception control programs stored in a memory 204 running on a program-controlled processor 203. The operations of the transmitter 10 and the receiver 12 or 13 are similar to those described with reference to FIGS. 3 and 4, and therefore details are omitted.

1. A method for delivering multimedia data from a transmitter to each of a plurality of receivers through a network, comprising the steps of:
at the transmitter,
a) delivering real-time multimedia data in multicast to the receivers while storing the real-time multimedia data into a first memory;
b) when having received a time-shift transition command from a receiver, reading time-shifted multimedia data from the first memory depending on the time-shift transition command;
c) transmitting the time-shifted multimedia data in unicast to the receiver which originated the time-shift transition command;
at the receiver,
receiving the real time multimedia data in multicast from the transmitter before transmitting the time-shift transition command; and
e) receiving the time shifted multimedia data in unicast from the transmitter after transmitting the time-shift transition command.

2. The method according to claim 1, wherein the step a) comprises:
adding a time stamp to each transmission block size of the real-time multimedia data;
storing the real-time multimedia data with time stamps into the first memory; and
delivering the real-time multimedia data with time stamps to the receivers.

3. The method according to claim 2, further comprising the steps of:
at each of the receivers,
creating a thumbnail picture from the real-time multimedia data received from the transmitter each time an amount of real-time multimedia data per unit time exceeds a predetermined level; and
storing thumbnail pictures with corresponding time stamps into a second memory so as to designate a desired thumbnail picture, allowing a desired location of the real-time multimedia data to be designated.

4. The method according to claim 3, further comprising the steps of:
when a time-shift request occurs, creating a time-shift transition command based on the thumbnail pictures with the corresponding time stamps stored in the second memory; and
transmitting the time-shift transition command to the transmitter so as to receive time-shifted multimedia data from the transmitter in unicast.

5. The method according to claim 1, wherein the time shift transition command is one of a replay start location designation command, a pause command, a reverse command, a slow-replay command, and a fast-forward command.

6. The method according to claim 1, further comprising the steps of:
at each of the receivers,
storing the real-time multimedia data received from the transmitter into a third memory; and
when a time-shift request occurs, reading time-shifted multimedia data from the third memory depending on the time-shift request.

7. The method according to claim 1, further comprising the steps of:
at the transmitter,
managing a delivery status including a transmission status, a transmission mode, and time information for each of the receivers.

8. A method for delivering multimedia data from a transmitter to each of a plurality of receivers through a network, comprising the steps of:
when having received a start request command from a receiver, the transmitter delivering real-time multimedia data in multicast to the receiver while storing the real-time multimedia data into a first memory;
when having received a time-shift transition command from the receiver, reading time-shifted multimedia data from the first memory depending on the time-shift transition command, to transmit the time-shifted multimedia data in unicast to the receiver which originated the time-shift transition command; and
when having received a termination request command from the receiver, the transmitter terminating multimedia data delivery to the receiver.

9. A system for delivering multimedia data from a transmitter to each of a plurality of receivers through a network, wherein
the transmitter comprises:
an input section for inputting real-time multimedia data;
a multicast transmitter for transmitting the real-time multimedia data to each of the receivers;
a first unicast transceiver for receiving a command from a receiver and transmitting a response to the receiver;
a command analyzer for analyzing a command received from the receiver to determine a type of the received command;
a first memory for storing the real-time multimedia data; and
a first controller controlling the multicast transmitter, the unicast transceiver and the first memory, such that the real-time multimedia data is delivered in multicast to each of the receivers while storing the real-time multimedia data into the first memory, wherein, when having received a time-shift transition command from a receiver, time-shifted multimedia data is read from the first memory depending on the time-shift transition command and is transmitted in unicast to the receiver which originated the time-shift transition command, and
each of the receivers comprises:
a multicast receiver for receiving the real-time multimedia data from the transmitter;
a second unicast transceiver for transmitting a command to the transmitter and receiving a response to the command from the transmitter; and
a second controller controlling such that the real-time multimedia data is received in multicast from the transmitter before transmitting the time-shift transition command, and the time-shifted multimedia data is received in unicast from the transmitter after transmitting the time-shift transition command.

10. The system according to claim 9, wherein the first controller adds a time stamp to each transmission block size of the real-time multimedia data, stores the real-time multimedia data with time stamps into the first memory, and delivers the real-time multimedia data with time stamps to the receivers.

11. The system according to claim 10, wherein each of the receivers further comprises a second memory, wherein the second controller creates a thumbnail picture from the real-time multimedia data received from the transmitter each time an amount of real-time multimedia data per unit time exceeds a predetermined level, and stores thumbnail pictures with corresponding time stamps into the second memory so as to designate a desired thumbnail picture, allowing a desired location of the real-time multimedia data to be designated.

12. The system according to claim 11, wherein when a time-shift request occurs, the second controller creates a time-shift transition command based on the thumbnail pictures with the corresponding time stamps stored in the second memory, and controls the second unicast transceiver to transmit the time-shift transition command to the transmitter so as to receive time-shifted multimedia data from the transmitter.

13. The system according to claim 9, wherein each of the receivers further comprises a third memory, wherein the second controller stores the real-time multimedia data received from the transmitter into the third memory and, when a time-shift request occurs, reads time-shifted multimedia data from the third memory depending on the time-shift request.

14. The system according to claim 9, wherein the first controller manages a delivery status including a transmission status, a transmission mode, and time information for each of the receivers.

15. A transmitter for delivering multimedia data to each of a plurality of receivers through a network, comprising:
an input section for inputting real-time multimedia data;
a multicast transmitter for transmitting the real-time multimedia data to each of the receivers;
a unicast transceiver for receiving a command from a receiver and transmitting a response to the receiver;
a command analyzer for analyzing a command received from the receiver to determine a type of the received command;
a memory for storing the real-time multimedia data; and
a controller controlling the multicast transmitter, the unicast transceiver and the memory, such that the real-time multimedia data is delivered in multicast to each of the receivers while storing the real-time multimedia data into the memory, wherein, when having received a time-shift transition command from a receiver, time-shifted multimedia data is read from the memory depending on the time-shift transition command and is transmitted in unicast to the receiver which originated the time-shift transition command.

16. A receiver for receiving multimedia data from a transmitter through a network, comprising:
a multicast receiver for receiving real-time multimedia data from the transmitter;
a unicast transceiver for transmitting a time-shift transition command to the transmitter and receiving a response to the time-shift transition command from the transmitter; and
a controller controlling such that the real-time multimedia data is received in multicast from the transmitter before transmitting the time-shift transition command, and the time-shifted multimedia data is received in unicast from the transmitter after transmitting the time-shift transition command.

17. A program instructing a computer to deliver multimedia data to each of a plurality of receivers through a network, comprising the steps of:
a) delivering real-time multimedia data in multicast to the receivers while storing the real-time multimedia data into a memory;
b) when having received a time-shift transition command from a receiver, reading time-shifted multimedia data from the memory depending on the time-shift transition command; and
c) transmitting the time-shifted multimedia data in unicast to the receiver which originated the time-shift transition command.

18. A program instructing a computer to receive multimedia data from a transmitter through a network, comprising the steps of:
receiving real-time multimedia data in multicast from the transmitter;
transmitting a time-shift transition command to the transmitter; and
after receiving a response to the time-shift transition command from the transmitter, receiving time-shifted multimedia data in unicast from the transmitter.
